(19) United States
(12) Patent Application Publication
(10) Pub. No.: US 2016/0216495 A1
(43) Pub. Date: Jul. 28, 2016

(54) Projection lens

(71) Applicant: Chia-Hung Sun, Taichung (TW)

(72) Inventor: Chia-Hung Sun, Taichung (TW)

(73) Assignees: Sintai Optical (Shenzhen) Co., Ltd., Shenzhen City (CN); Asia Optical International Ltd., Tortola (GB)

(21) Appl. No.: 14/998,550

(22) Filed: Jan. 19, 2016

(30) Foreign Application Priority Data
Jan. 26, 2015 (CN) 201510038921.1

(51) Int. Cl. G02B 13/16; G02B 27/00; G02B 9/60

(52) U.S. Cl. CPC G02B 13/16; G02B 9/60; G02B 27/0025

(57) ABSTRACT

A projection lens includes a first lens group and a second lens group, all of which are arranged in sequence from a projection side to an image source side along an optical axis. The first lens group is with negative refractive power and includes a first lens with negative refractive power. The second lens group is with positive refractive power and includes a second lens, a third lens, a fourth lens and a fifth lens, wherein the second lens is with positive refractive power, the third lens is with negative refractive power, the fourth lens is a concave-convex lens with positive refractive power and the fifth lens is with positive refractive power. The first lens group and the second lens group satisfy −1.8<f1/f2<−1.42, wherein f1 is an effective focal length of the first lens group and f2 is an effective focal length of the second lens group.

### BACKGROUND OF THE INVENTION

1. Field of the Invention

The invention relates to a projection lens.

2. Description of the Related Art

In general, a projection lens uses aspheric lens technology to correct the aberration problem. However, the use of aspheric lens technology often increases the manufacturing difficulty and the cost. Further, the high temperature generated by the projector may degrade the image quality of the projection lens (especially that of a high brightness projector). Therefore, a projection lens with new structure is necessary in order to overcome the above two problems and meet the market demand.

### BRIEF SUMMARY OF THE INVENTION

The invention provides a projection lens to solve the above problems. The projection lens, without using aspheric lens technology to correct aberration, still have good optical performance and resolution, and can reduce the manufacturing difficulty and cost. Further, all of the lenses of the invention are made of glass instead of plastic in order to reduce the influence of the environmental temperature on the image quality of the projection lens.

The projection lens in accordance with an exemplary embodiment of the invention includes a first lens group and a second lens group, all of which are arranged in sequence from a projection side to an image source side along an optical axis. The first lens group is with negative refractive power and includes a first lens with negative refractive power. The second lens group is with positive refractive power and includes a second lens, a third lens, a fourth lens and a fifth lens, all of which are arranged in sequence from the projection side to the image source side along the optical axis, wherein the second lens is with positive refractive power, the third lens is with negative refractive power, the fourth lens is a concave-convex lens with positive refractive power and the fifth lens is with positive refractive power. The first lens group and the second lens group satisfy −1.8<f1/f2<−1.42, wherein f1 is an effective focal length of the first lens group and f2 is an effective focal length of the second lens group.

In another exemplary embodiment, all of the first lens, the second lens, the third lens, the fourth lens and the fifth lens are spherical lenses.

In yet another exemplary embodiment, an Abbe number of the first lens is greater than 50.

In another exemplary embodiment, an index of refraction of the first lens is less than 1.6.

In yet another exemplary embodiment, an Abbe number of the second lens, an Abber number of the third lens and an Abber number of the fourth lens are less than 50.

In another exemplary embodiment, an Abbe number of the fifth lens is greater than 50.

In yet another exemplary embodiment, an index of refraction of the third lens is greater than 1.65.

In another exemplary embodiment, an index of refraction of the second lens, an index of refraction of the fourth lens and an index of refraction of the fifth lens are greater than 1.65.

In yet another exemplary embodiment, the second lens group further includes a stop disposed between the second lens and the third lens.

In another exemplary embodiment, the first lens is made of crown glass material.

In yet another exemplary embodiment, the second lens is made of flint glass material.

In another exemplary embodiment, the third lens is made of flint glass material.

In yet another exemplary embodiment, the fourth lens is made of flint glass material.

In another exemplary embodiment, the fifth lens is made of crown glass material.

A detailed description is given in the following embodiment with reference to the accompanying drawings.

### BRIEF DESCRIPTION OF THE DRAWINGS

The invention can be more fully understood by reading the subsequent detailed description and example with references made to the accompanying drawings, wherein:

FIG. 1 is a lens layout and optical path diagram of a projection lens in accordance with an embodiment of the invention;

FIG. 2A is a field curvature diagram of the projection lens in accordance with the embodiment of the invention;

FIG. 2B is a distortion diagram of the projection lens in accordance with the embodiment of the invention;

FIG. 2C is a modulation transfer function diagram of the projection lens in accordance with the embodiment of the invention;

FIG. 2D is a through focus modulation transfer function diagram of the projection lens in accordance with the embodiment of the invention; and

FIG. 2E is a relative illumination diagram of the projection lens in accordance with the embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

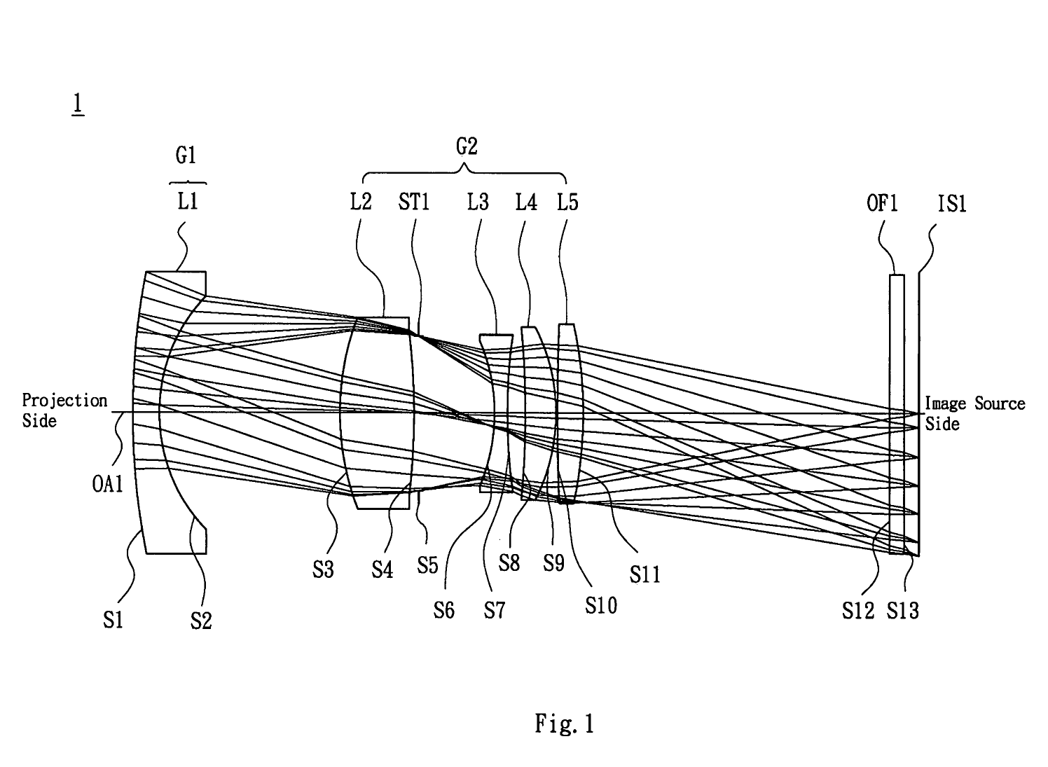

Referring to FIG. 1, FIG. 1 is a lens layout and optical path diagram of a projection lens in accordance with an embodiment of the invention. The projection lens 1 includes a first lens group GI, a second lens group G2 and an optical filter OF1, all of which are arranged in sequence from a projection side to an image source side along an optical axis OA1. In operation, light rays from an image source IS1 are projected on the projection side. The first lens group G1 is with negative refractive power and includes a first lens L1. The first lens L1 is a convex-concave lens with negative refractive power, made of crown glass material and includes a convex surface Si facing the projection side and a concave surface S2 facing the image source side, wherein both of the convex surface S1 and concave surface S2 are spherical surfaces. In general, an Abbe number of the crown glass is greater than 50. The second lens group G2 is with positive refractive power and includes a second lens L2, a stop ST1, a third lens L3, a fourth lens L4 and a fifth lens L5, all of which are arranged in sequence from the projection side to the image source side along the optical axis OA1. The second lens L2 is a biconvex lens with positive refractive power, made of flint glass material and includes a convex surface S3 facing the projection side and a convex surface S4 facing the image source side, wherein both of the convex surface S3 and convex surface S4 are spherical surfaces. In general, an Abbe number of the flint glass is less than 50. The third lens L3 is a biconcave lens with negative refractive power, made of flint glass material and includes a concave surface S6 facing the projection side and a concave surface S7 facing the image source side, wherein both of the concave surface S6 and concave surface S7 are spherical surface. The fourth lens L4 is a concave-convex lens with positive refractive power, made of flint glass material and includes a concave surface S8 facing the projection side and a convex surface S9 facing the image source side, wherein both of the concave surface S8 and convex surface S9 are spherical surfaces. The fifth lens L5 is a biconvex lens with positive refractive power, made of crown glass material and includes a convex surface S10 facing the projection side and a convex surface S11 facing the image source side, wherein both of the convex surface S10 and convex surface S11 are spherical surfaces. Both of the projection side surface S12 and image source side S13 of the optical filter OF1 are plane surfaces.

In order to maintain excellent optical performance of the projection lens in accordance with the embodiment of the invention, the projection lens 1 must satisfies the following six conditions:

−1.8<f1/f2≦−1.42 (1)

Nd₁<1.6 (2)

Nd₂>1.65 (3)

Nd₃>1.65 (4)

Nd₄>1.65 (5)

Nd₅>1.65 (6)

wherein f1 is an effective focal length of the first lens group G1, f2 is an effective focal length of the second lens group G2, Nd₁ is an index of refraction of the first lens L1, Nd₂ is an index of refraction of the second lens L2, Nd₃ is an index of refraction of the third lens L3, Nd₄ is an index of refraction of the fourth lens L4 and Nd₅ is an index of refraction of the fifth lens L5.

By the above design of the lenses and stop ST1, the projection lens 1 is provided with an effective corrected aberration, a resolution of the lens can be increased, and a negative influence of environmental temperature change on the optical performance can be reduced. Thus, the image quality can be good.

In order to achieve the above purpose and effectively enhance the optical performance, the projection lens 1 in accordance with the embodiment of the invention is provided with the optical specifications shown in Table 1, which include curvature of each lens surface, thickness between adjacent surface, refractive index of each lens, and Abbe number of each lens.

TABLE 1

| Surface | Curvature | Thickness | | | |
|---|---|---|---|---|---|
| Number | (mm⁻¹) | (mm) | Nd | Vd | Remark |
| S1 | 0.024 | 2 | 1.52 | 64 | The First Lens L1 |
| S2 | 0.081 | 14.3 | | | |
| S3 | 0.052 | 5.5 | 1.77 | 49 | The Second Lens L2 |
| S4 | −0.019 | 0.3 | | | |
| S5 | 0 | 5.4 | | | Stop ST1 |
| S6 | −0.071 | 1.2 | 1.78 | 25 | The Third Lens L3 |
| S7 | 0.03 | 1.4 | | | |
| S8 | −0.016 | 2.3 | 1.79 | 47 | The Fourth Lens L4 |
| S9 | −0.072 | 0.1 | | | |
| S10 | 0.015 | 1.5 | 1.68 | 55 | The Fifth Lens L5 |
| S11 | −0.025 | 22.2 | | | |
| S12 | 0 | 1.05 | 1.48 | 70.2 | Optical Filter OF1 |
| S13 | 0 | 0.703 | | | |

For the projection lens 1 of the embodiment, the effective focal length f1 of the first lens group G1 is equal to −36.89 mm, the effective focal length f2 of the second lens group G2 is equal to 22.05 mm, the index of refraction Nd₁ of the first lens L1 is equal to 1.52, the index of refraction Nd₂ of the second lens L2 is equal to 1.77, the index of refraction Nd₃ of the third lens L3 is equal to 1.78, the index of refraction Nd₄ of the fourth lens L4 is equal to 1.79 and the index of refraction Nd₅ of the fifth lens L5 is equal to 1.68. According to the above data, the following values can be obtained:

f1/f2=−1.67,

Nd₁=1.52,

Nd₂=1.77,

Nd₃=1.78,

Nd₄=1.79,

Nd₅=1.68,

which respectively satisfy the above conditions (1)-(6).

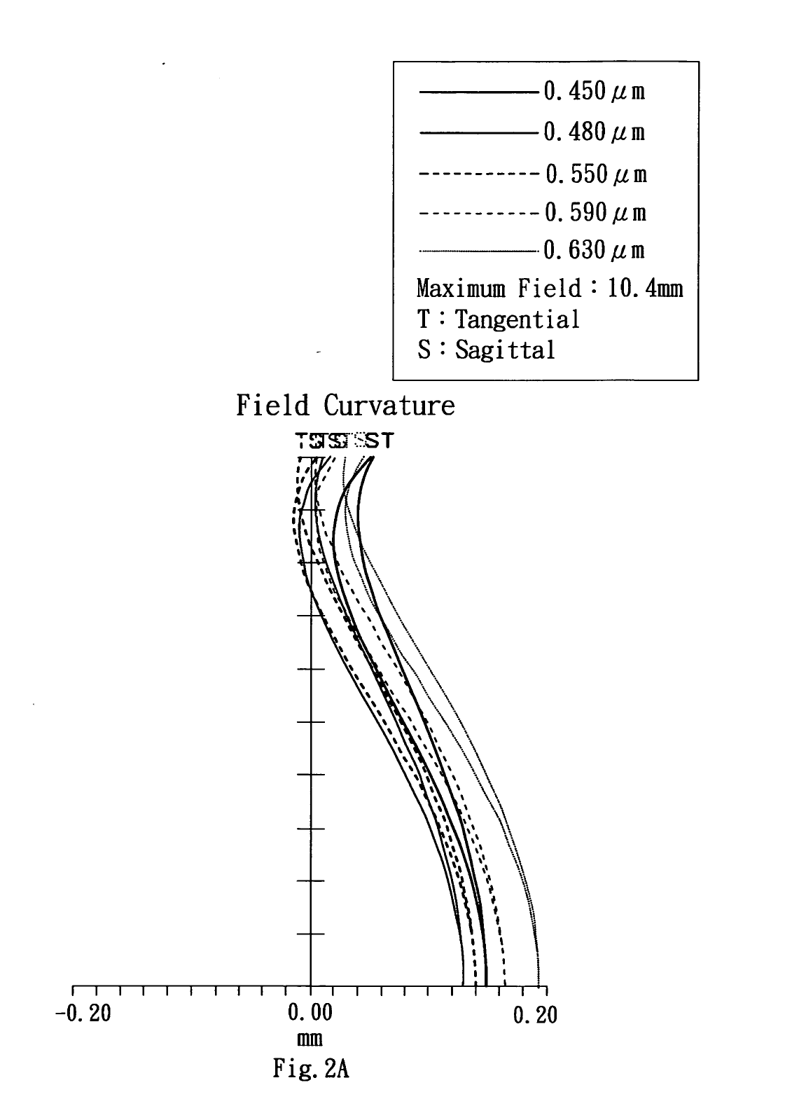

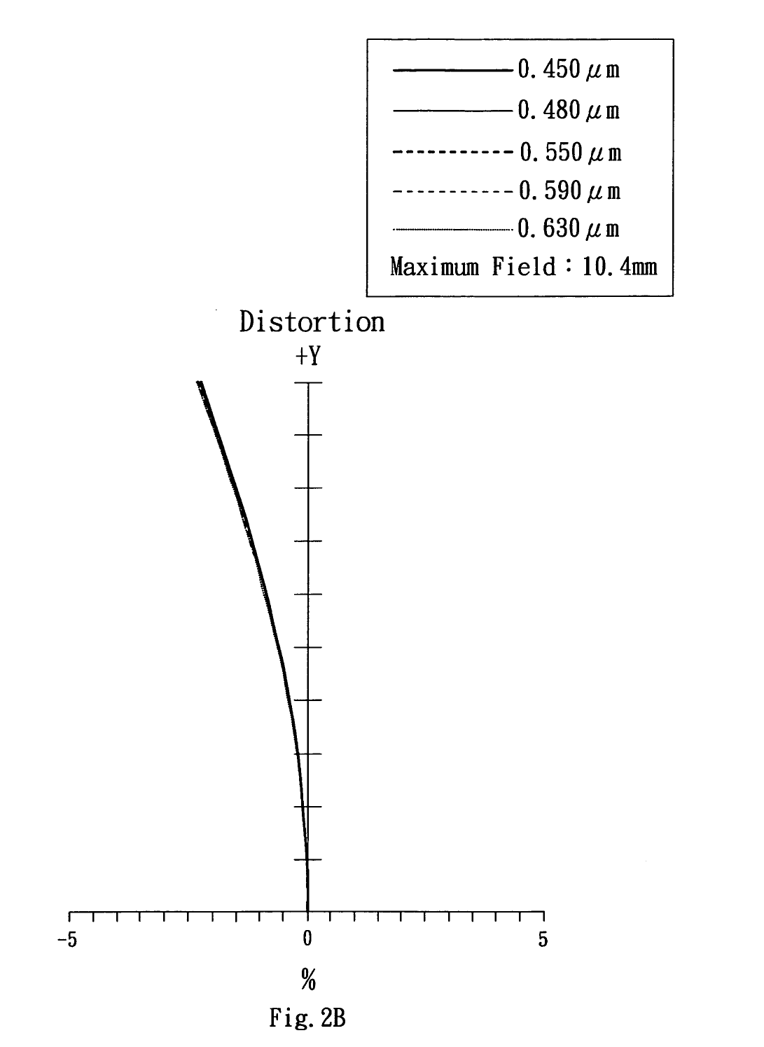

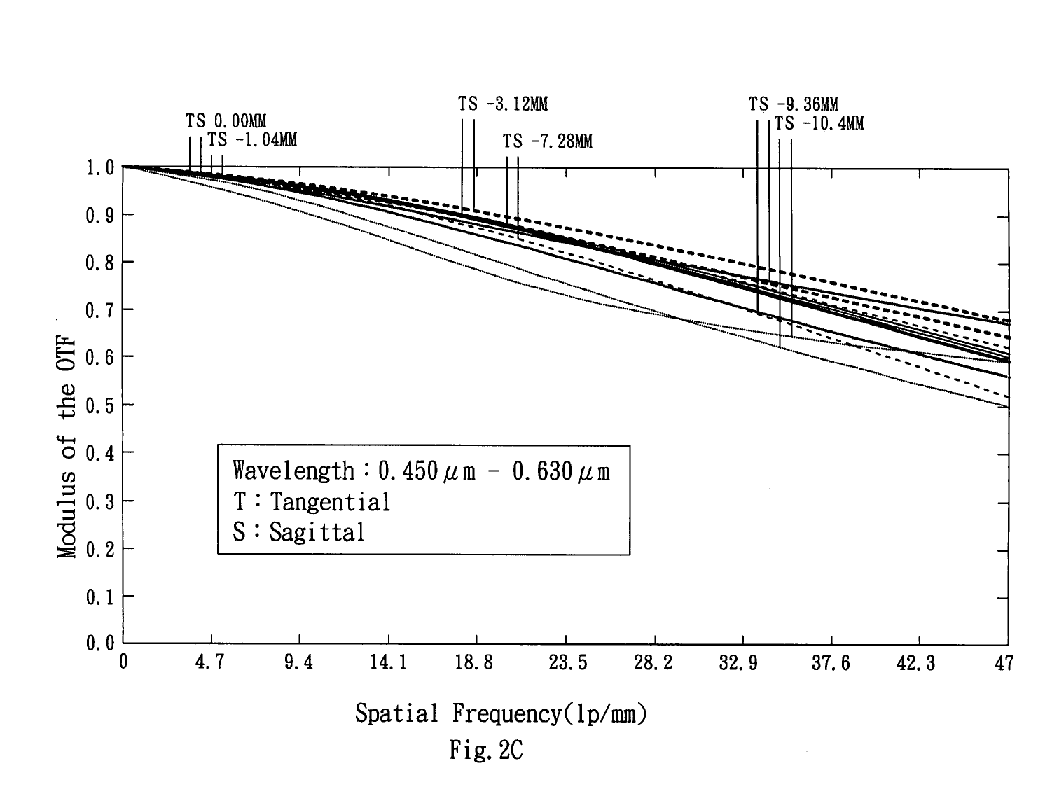

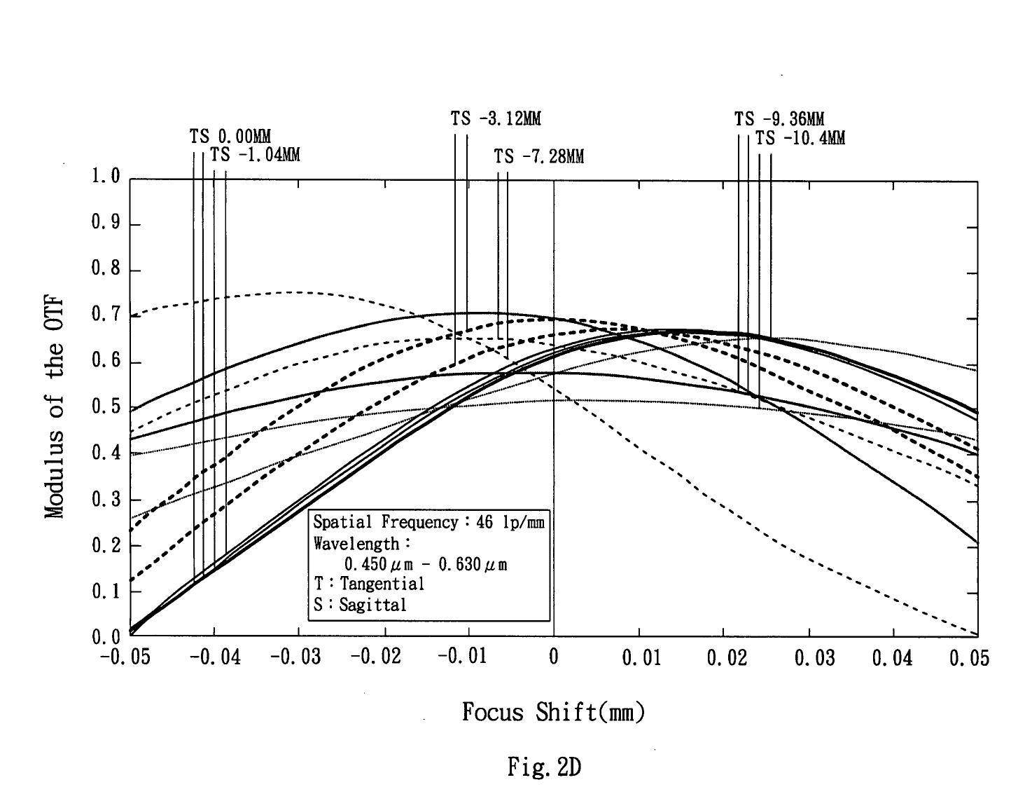

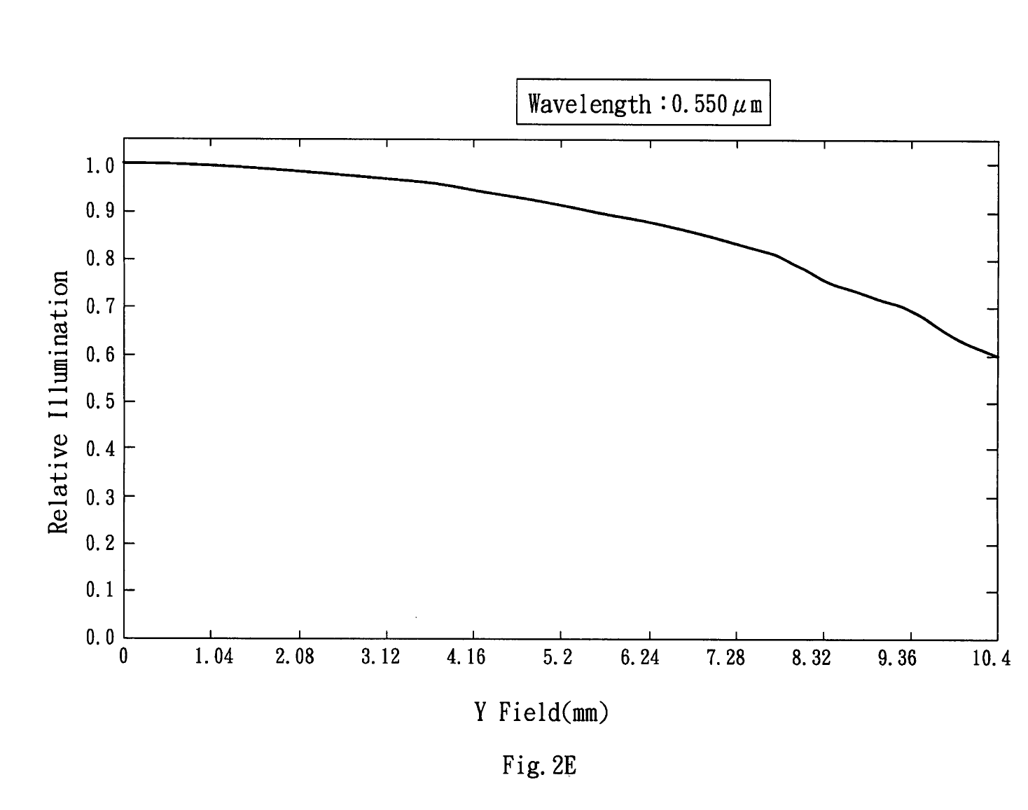

By the above arrangements of the lenses and stop ST1, the projection lens 1 of the embodiment can meet the requirements of optical performance as seen in FIGS. 2A-2E, wherein FIG. 2A shows the field curvature diagram of the projection lens 1 in accordance with the embodiment of the invention, FIG. 2B shows the distortion diagram of the projection lens 1 in accordance with the embodiment of the invention, FIG. 2C shows the modulation transfer function diagram of the projection lens 1 in accordance with the embodiment of the invention, FIG. 2D shows the through focus modulation transfer function diagram of the projection lens 1 in accordance with the embodiment of the invention, and FIG. 2E shows the relative illumination diagram of the projection lens 1 in accordance with the embodiment of the invention.

It can be seen from FIG. 2A that the field curvature of tangential direction and sagittal direction in the projection lens 1 of the present embodiment ranges from −0.02 mm to 0.20 mm for the wavelength of 0.450 μm, 0.480 μm, 0.550 μm, 0.590 μm and 0.630 μm. It can be seen from FIG. 2B (in which the five lines in the figure almost coincide to appear as if a signal line) that the distortion in the projection lens 1 of the present embodiment ranges from −2.5% to 0% for the wavelength of 0.450 μm, 0.480 μm, 0.550 μm, 0.590 μm and 0.630 μm. It can be seen from FIG. 2C that the modulation transfer function of tangential direction and sagittal direction in the projection lens 1 of the present embodiment ranges from 0.50 to 1.0 when the wavelength ranges from 0.450 μm to 0.630 μm, the fields respectively are 0.00 mm, −1.04 mm, −3.12 mm, −7.28 mm, −9.36 mm and −10.40 mm, and the spatial frequency ranges from 0 lp/mm to 47 lp/mm. It can be seen from FIG. 2D that the through focus modulation transfer function of tangential direction and sagittal direction in the projection lens 1 of the present embodiment is greater than 0.2 as focus shift ranges from −0.036 mm to 0.027 mm wherein the wavelength ranges from 0.450 μm to 0.630 μm, the fields respectively are 0.00 mm, −1.04 mm, −3.12 mm, −7.28 mm, −9.36 mm and −10.40 mm, and spatial frequency is equal to 46 lp/mm. It can be seen from FIG. 2E that the relative illumination in the projection lens 1 of the present embodiment ranges from 0.6 to 1.0 when the wavelength is 0.550 μm and Y field ranges from 0 mm to 10.4 mm. It is obvious that the field curvature and the distortion of the projection lens 1 of the present embodiment can be corrected effectively, and the resolution, the depth of focus and the relative illumination of the projection lens 1 of the present embodiment can meet the requirement. Therefore, the projection lens 1 of the present embodiment is capable of good optical performance.

What is claimed is:

1. A projection lens comprising a first lens group and a second lens group, all of which are arranged in sequence from a projection side to an image source side along an optical axis, wherein:
the first lens group is with negative refractive power and comprises a first lens, wherein the first lens is with negative refractive power;
the second lens group is with positive refractive power and comprises a second lens, a third lens, a fourth lens and a fifth lens, all of which are arranged in sequence from the projection side to the image source side along the optical axis, wherein the second lens is with positive refractive power, the third lens is with negative refractive power, the fourth lens is a concave-convex lens with positive refractive power and the fifth lens is with positive refractive power; and
the first lens group and the second lens group satisfy:
−1.8<f1/f2<−1.42
wherein f1 is an effective focal length of the first lens group and f2 is an effective focal length of the second lens group.

2. The projection lens as claimed in claim 1, wherein all of the first lens, the second lens, the third lens, the fourth lens and the fifth lens are spherical lenses.

3. The projection lens as claimed in claim 1, wherein an Abbe number of the first lens is greater than 50.

4. The projection lens as claimed in claim 1, wherein an index of refraction of the first lens is less than 1.6.

5. The projection lens as claimed in claim 1, wherein an Abbe number of the second lens, an Abber number of the third lens and an Abber number of the fourth lens are less than 50.

6. The projection lens as claimed in claim 5, wherein an Abbe number of the

7. The projection lens as claimed in claim 1, wherein an index of refraction of the third lens is greater than 1.65.

8. The projection lens as claimed in claim 7, wherein an index of refraction of the second lens, an index of refraction of the fourth lens and an index of refraction of the fifth lens are greater than 1.65.

9. The projection lens as claimed in claim 1, wherein the second lens group further comprises a stop disposed between the second lens and the third lens.

10. The projection lens as claimed in claim 1, wherein the first lens is made of crown glass material.

11. The projection lens as claimed in claim 1, wherein the second lens is made of flint glass material.

12. The projection lens as claimed in claim 1, wherein the third lens is made of flint glass material.

13. The projection lens as claimed in claim 1, wherein the fourth lens is made of flint glass material.

14. The projection lens as claimed in claim 1, wherein the fifth lens is made of crown glass material.
